(19) United States
(12) Patent Application Publication
(10) Pub. No.: US 2008/0133766 A1
(43) Pub. Date: Jun. 5, 2008

(54) METHOD AND APPARATUS FOR STREAMING MEDIA TO A PLURALITY OF ADAPTIVE CLIENT DEVICES

(76) Inventor: Wenjun Luo, Cupertino, CA (US)

Correspondence Address: PILLSBURY WINTHROP SHAW PITTMAN LLP, P.O. BOX 10500, MCLEAN, VA, 22102, US

(21) Appl. No.: 11/745,434

(22) Filed: May 7, 2007

Related U.S. Application Data
(60) Provisional application No. 60/797,486, filed on May 5, 2006.

(51) Int. Cl. G06F 15/16

(52) U.S. Cl. 709/231; 709/246; 709/227

(57) ABSTRACT

The present invention relates to a method and apparatus for streaming media to a plurality of adaptive client devices. In one aspect there is provided a method of providing a media stream over data channel of a best effort transmission network that includes a wireless path to a plurality of client devices. In another aspect there is provided a method of encoding a stream of data into chunks, whereby the chunks are obtained by determining a break point between them that corresponds to a silence point. In another aspect, there is provided a method for creating a library of encoded media for a media stream and linking the library to a plurality of cell phone devices.

### CLAIM OF PRIORITY

This application claims priority from U.S. Provisional Application No. 60/797,486 titled “An End-To-End System That Delivers Full Version Of Long Form Content To Small Screen Terminals By Combining Text, Image And Streaming Media, And Employing A Client Only Adaptive Bit Rate Adjustment Mechanism Based On Multi-Rate Chunking To Ensure Uninterrupted Streaming In Real-Time In The Face Of Fluctuating Bandwidth Available To The Streaming Session” and filed on May 5, 2006, the contents of which are expressly incorporated by reference herein.

### FIELD OF THE INVENTION

The present invention relates to a method and apparatus for streaming media to a plurality of adaptive client devices.

### BACKGROUND OF THE INVENTION

Wireless networks are well known in which many thousands of client wireless devices share the same network bandwidth. Cellular phones are one such example.

In a typical network, wireless network bandwidth fluctuates for a variety of reasons, including channel sharing between different client wireless devices, as well as changing conditions, environmental or otherwise, between the client wireless devices and a base station with which they communicate, as well as changes between the base station and other [servers] that are accessed for purposes of obtaining content.

Bandwidth sharing among applications on the same client wireless device, if instituted, is another reason for network bandwidth fluctuations, since bandwidth available to each application can also fluctuate.

One known method of transmission with a client device is to use constant bit rate streaming. Users experience poor streaming media quality when available bandwidth is lower than the streaming bit rate, as undesired gaps in the stream occur, which thus cause gaps in the audio or other content being experienced.

In order to overcome the disadvantages of constant bit rate streaming, it is also known to use a streaming server that can adapt its streaming bit rate dynamically. While such dynamic adaptation has advantages, such an approach does not scale well if the streaming server streams a large number of streams, such as tens of thousands. This is because the streaming server needs to fully understand the syntax of the transmitted media bit stream and process the adaptive bit rate request in a sophisticated manner that requires intensive computation processing such as time synchronization, and header seeking within the media bit stream.

### SUMMARY OF THE INVENTION

The present invention relates to a method and apparatus for streaming media to a plurality of adaptive client devices.

In one aspect there is provided a method of providing a media stream over data channel of a best effort transmission network that includes a wireless path to a plurality of client devices.

In another aspect there is provided a method of encoding a stream of data into chunks, whereby the chunks are obtained by determining a break point between them that corresponds to a silence point.

In another aspect, there is provided a method for creating a library of encoded media for a media stream and linking the library to a plurality of cell phone devices.

### BRIEF DESCRIPTION OF THE DRAWINGS

These and other aspects and features of the present invention will become apparent to those of ordinary skill in the art upon review of the following description of specific embodiments of the invention in conjunction with the accompanying figures, wherein:

FIGS. 1(a), (b) and (c) together illustrate communications in the wireless network according to the present invention;

FIG. 2 illustrates a buffer within a client device according to the present invention;

FIG. 3(a) illustrates a representation of an audio sequence, and various break points within the sequence that are used to establish raw chunks according to the present invention and FIG. 3(b) illustrates adaptive encoding for generating from raw chunks encoded chunks for multiple cellphone classes according to the present invention;

FIG. 4 illustrates a flowchart of an intelligent chunk mechanism for audio according to the present invention.

FIG. 5 illustrates a flowchart of an adaptive transmission control algorithm according to the present invention;

FIG. 6 illustrates another flowchart of an adaptive transmission control algorithm according to the present invention;

### DESCRIPTION OF THE PREFERRED EMBODIMENTS

The present invention provides an end-to-end system that delivers full version of long form content to small screen terminals/client devices in streaming (real-time) fashion and minimize the on-off interruption in the context of fluctuating bandwidth. As described further herein, in a preferred embodiment, the present invention employs an intelligent chunking mechanism that segments a continuous stream of unencoded/uncompressed media data into raw chunks, a multi-rate, multi client encoder that generates a library of streaming media in encoded chunks for an array of different classes of client devices, a client only adaptive adjustment mechanism for various bit rates and compression scheme combinations that is based on multi-client, multi-rate encoding of raw chunks to ensure uninterrupted streaming in real-time in the face of fluctuating bandwidth available to the streaming session and a mechanism to transmit and display on the device screen media such as video, text, flash, or an image, with or without a hyperlink, while audio is being streamed as described herein and played through the device's audio output device, and particularly when the audio buffer is full or larger than certain threshold, since when audio buffer occupancy is larger than a threshold, it is safer to download other content, without causing the buffer to deplete.

As described herein, usage of the intelligent chunking mechanism, in combination with the multi-rate, multi client encoder, provides advantages over usage of continuous bit streams that are conventionally used for streamed content These advantages include 1) simplifying the streaming server and the client since each raw chunk (or just “chunk” as used herein) is independently encoded leading to independency between chunks, and more particularly to independency between different files that contain different encoded chunks. As a result, when the streaming server and the client deal with adaptive transmissions, adaptation all is done on the encoded chunk level. There is no need for the streaming server and/or the client to probe into the bit stream and seek for certain header and timing information so as to determine the breaking points in the continuous bitstream at which to switch to another bit stream (encoded at a different bit rate); 2). Another benefit from the chunking approach is the support of multiple compression schemes to accommodate more diverse bit rate change 3). Since each encoded chunk is preferably represented as a file, caching of the files in the network save data server bandwidth, whereas a continuous bit stream can not be cached; 4) client device implementation is simplified as the client simply requests the file that corresponds to a chunk encoded at a particular bit rate/compression scheme combination (in contrast to sophisticated streaming protocols such as RTSP). As a result, low-resource cellphones can be supported. 5) natural support for text-based content sources that are converted to audio using a text-to-speech engine as text can be naturally broken into text segments based on sentence stops such as a period sign or a comma sign. Then each text segment is converted to an audio chunk via a text to speech engine;

In addition to using an intelligent chunk mechanism and a multi-client multi-rate encoding mechanism, usage of a client only approach can greatly simply the streaming server on which content is stored and achieve much better scalability because the server can be stateless.

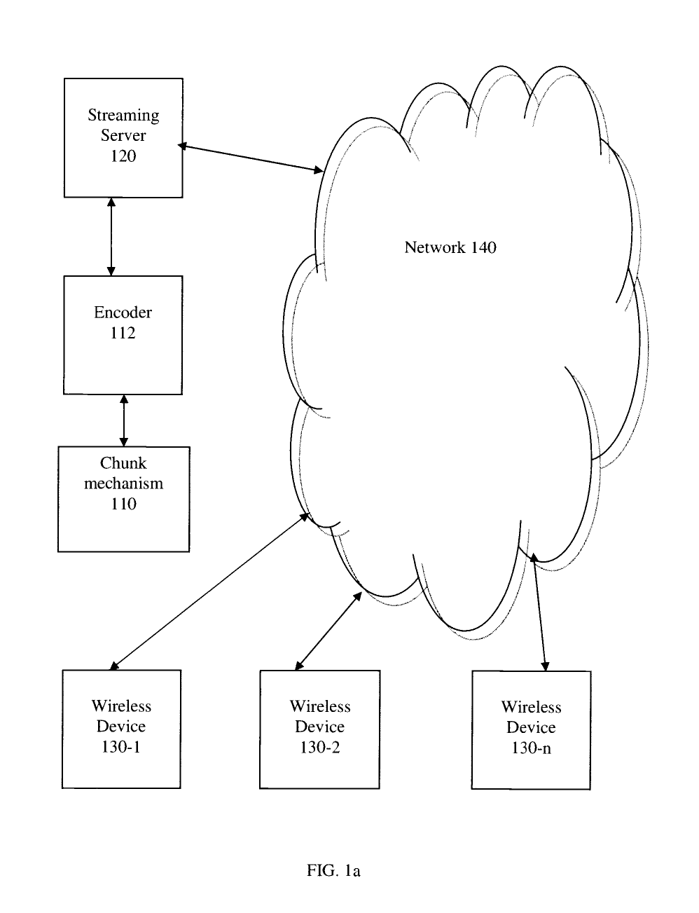

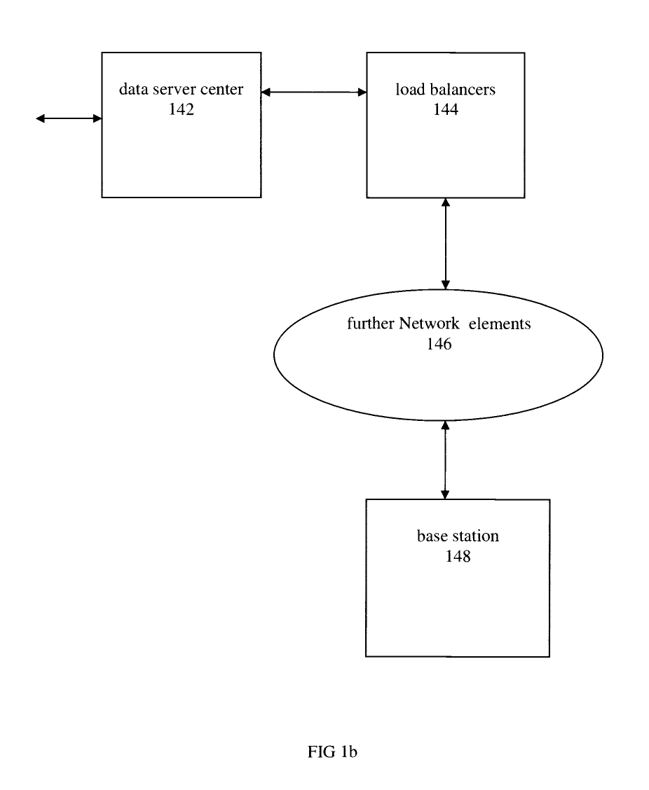

FIGS. 1(a), (b) and (c) illustrate the system 100 of the present invention, and the manner of communication between the various elements, particularly the steaming/web server and the client as shown in FIG. 1(c), and that a client device can adaptively retrieve encoded chunks via standard file transferring protocol, e.g., HTTP, greatly simplifying the streaming server.

The system 100 includes an intelligent chunk mechanism 110, a multi-rate, multi client encoder 112, which provides multi-rate, multi-client encoded content, described further hereinafter, to a streaming server 120. The streaming server 120 serves the content to each of a plurality of client devices 130-(1, 2, 3, n), preferably wireless client devices, through a transmission network 140.

A representative portion of the transmission network 140 is illustrated in FIG. 1(b), and may include a web server data center 142, load balancers 144 (which load balancers can take the form of either cache servers distributed around the network, or a virtual server having an IP address and port to the client devices, which virtual server is bound to a number of physical servers that provide the redundant or different services), other network elements 146 (such as routers, and cache servers), and a base station 148 that provides for wireless communications with the client devices 130 within its range. It should be understood, however, that while only a few client devices 130 are shown, the labeling from 130-1 to 130-n is to show the intended scale of the present invention in which very many, in the hundreds and thousands, of different client devices 130 are capable of operating simultaneously, with an appropriately scaled network 140 that will include many different base stations 148 and other network elements.

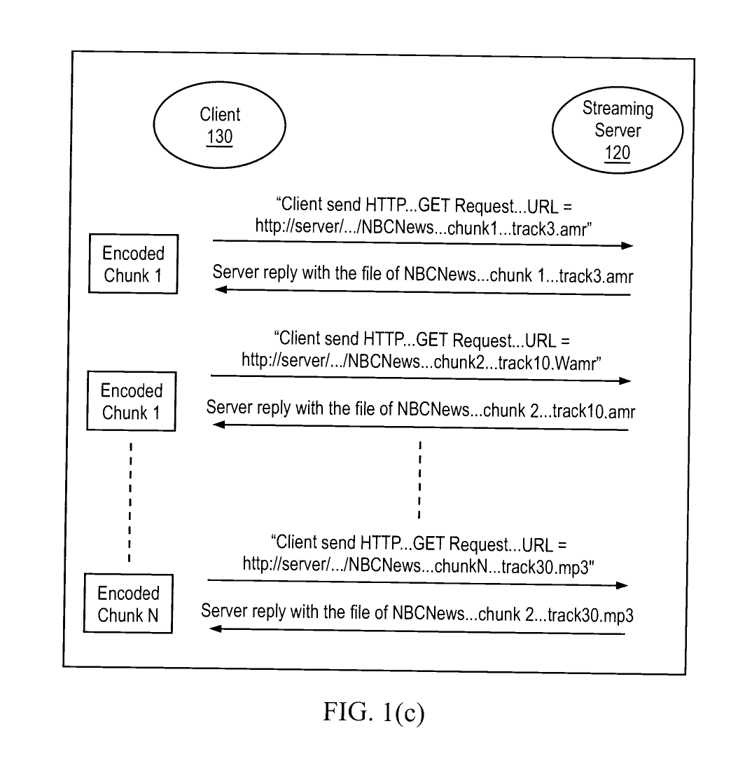

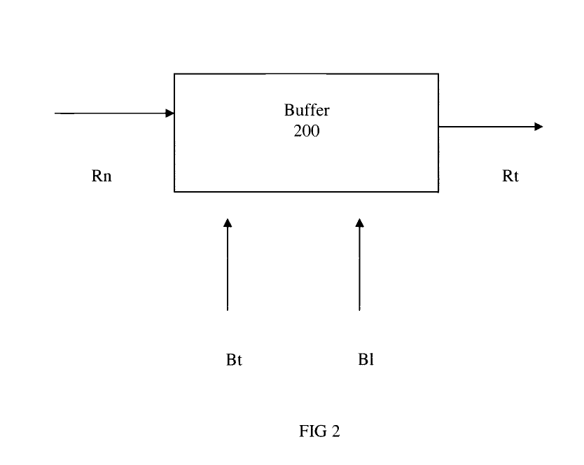

The client devices 130 include conventional hardware such as transmitter and receiver circuits, a processor, a memory, a user interface, and some type or types of content delivery mechanism, such as a speaker or display unit. The processor, among other functions, will execute a program 132 that provides for the functionality of the present invention as described, which program will reside in an application area of the memory, and allow the downloading of content into a buffer, which content is then ultimately provided from the buffer to the content rendering mechanism (an audio player or a video player) so that it can be rendered and thus presented to the user. The buffer of the client device 130 is functionally illustrated in FIG. 2 as buffer 200, and contains as inputs the content data from a network input 210, and outputs the content data a an output 220, for further rendering as will be described herein. Monitored from the buffer 200 is the number of encoded chunks of content data that are in the buffer at a given time. The usage of this monitored variable will become apparent from the discussion hereinafter.

The basic mechanism of providing multi-rate content according to the present invention is described in detail below using the example of audio. Other streaming media formats can be treated in a similar manner, and modifications for different formats are also described further hereinafter.

With respect to this example, a particular audio source file is segmented into raw chunks (or just “chunks”) using the intelligent chunking mechanism 110 illustrated in FIG. 1, the length of each chunk depends on a number of factors: the frequency of wireless bandwidth change, average network bandwidth, intrinsic nature of media (minimum contiguous block of information), buffer size at the client, maximum latency requirement. All these parameters can be optimized mathematically for a particular set of scenarios, although other considerations with respect to chunks, and in particular where to begin and end them, are described further hereinafter. A typical length for each chunk, however, is in the range of 5-10 seconds of content for an average network bandwidth of 10 kbps and a maximum latency of a few seconds. If the network average bandwidth is higher or the latency requirement is lower, the chunk duration can be adjusted proportionally. This also allows, with the implementation of intelligent chunking as described further hereinafter, for the chunks to vary within some range of a preferred chunk length, such as 7 second+/−2 or 3 seconds, during which 4 or 6 second interval for this range, selection therein of a preferred segmentation point can occur.

The intelligent chunking mechanism 110 is preferably adapted to operate upon different types of content, audio, both audio and video, as well as text.

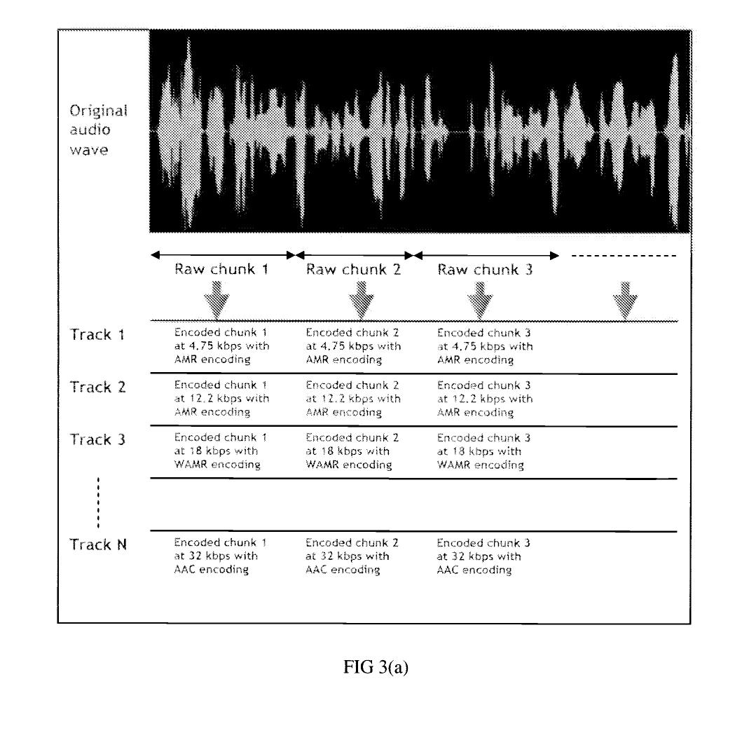

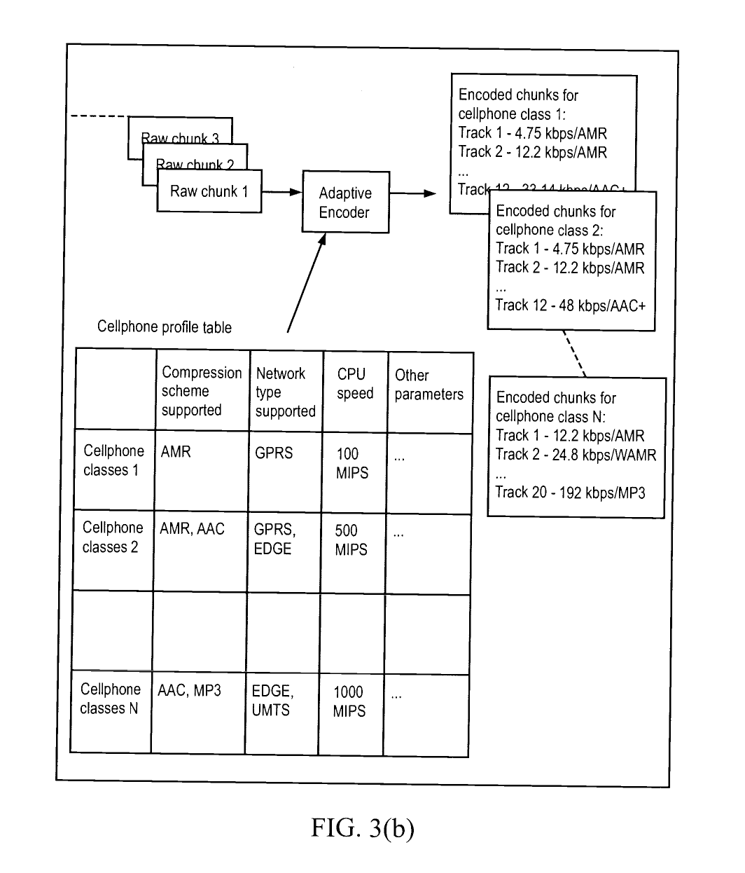

FIG. 3 illustrates a representation of an audio sequence within an audio file, and two different embodiments that can be used to establish various break points within the sequence, which break points thus define the chunks according to the present invention.

The first, shown by break points 310, are each made so that each chunk has the same period of time. While this has ease of implementation aspects with respect the subsequent encoding of the chunks, as well as with respect to the client device 130, a disadvantage can be that users may sense a brief pause in the middle of a sentence if the content is audio, for example, as the audio player on the client device 130 switches from the finished encoded chunk to the next encoded chunk. Accordingly an intelligent chunk algorithm is used to segment the streaming content data at appropriate break points, which are not typically purely periodic.

FIG. 4 illustrates a flowchart of an intelligent chunk algorithm 400 according to the present invention, which is directed to an example using audio. Generally, this algorithm is used to have break point correspond to a point of relative “silence” point to minimize any break effect. In particular, the silence point can be defined in a number of ways, one being the point at which the amplitude is less than a certain threshold (for example, 5% of maximum amplitude). Using this, the algorithm, which is implemented as a computer program, will first, in step 410, start the data content sequence, and then, in step 420, skip forward a set amount, typically 7 seconds. In step 430, a window around this skip forward point is viewed to determine if there exists a silence point therein. A wave representation of the audio file can be used when making this determination. If there exists a silence point within the window, then that point is selected as the break point in step 440. The sequence then goes step 460 to determine if there is an end to the data stream. If so, then the algorithm ends, but if not, then there is a return back to step 420. If a silence point does not exist within step 430, then the lowest amplitude within the window, the skip forward point, or some other point within the window is chosen as the break point in step 420. Thereafter, step 460 follows.

For a stream that includes both audio and video, either the audio or video can be used to determine the break point. Preferably the audio is used, and the video break point is made the same. But other methodologies can be used, including using the video scene change.

For a pure video stream without an audio component, a scene-change point, where there is a significant change in the background is used, and can be detected by looking at the difference between two consecutive video frames. One detection mechanism is to use a difference threshold, and if the difference is larger than that threshold, that is referred to as a scene change that is appropriate to use as a break point.

Another type of content is live audio. Chunking takes place in a manner that is the same as for a large pre-recorded audio file as described above, except that the live content is chunked in real-time.

Another type of content is a pre-stored large text file. Such a text file is preferably first chunked based upon text breaks, including but not limited to the period sign, commas, as well as more sophisticated divisions (such as not causing a break between a subject and verb that are adjacent to each other). Once chunked in text form, the intelligent chunker will convert each text chunk to an audio chunk using a text-to-speech engine (not shown).

Real-time text, such as an RSS feed, is handled in the same way as a large pre-stored text file as described above, except that the real-time text is chunked in real time.

The multi-client multi-rate encoder 112 inputs the chunks that have been obtained by the intelligent chunker 110 described above, and for each of the different type of client devices 130, taking into account the specifications the client type, the type of compression scheme being supported on the client device 130, and the type of wireless network that the particular type of client device 130 operates upon, encode each chunk at a plurality of different bit rates/compression scheme combination, with each bite rate/compression scheme combination corresponding to a so-called track. This is shown also in FIG. 3(b) to illustrate adaptive encoding for generating encoded chunks for an example of multiple cellphone classes. For audio streams, coding will vary, from a few kbps, all the way to several hundreds of kbps (for audio), and it depends on a specific compression scheme chosen. For example, if AMR is used, there are only 8 combinations, all using the same compression scheme, at 4.75 kbps, 5.15 kbps, 5.9 kbps, 6.7 kbps, 7.4 kbps, 7.95 kbps, 10.20 kbps, 12.20 kbps, and wideband AMR, there are 9 bit rates with this compression scheme, and if MP3 or AAC is used, still other bit rates can be used with these compression schemes. Thus, for example, certain cellphones will have the capability to use a set of combinations of tracks that have different compression algorithms and bit rates, while the set of combinations used by other cellphones may only rely on the same compression scheme with different bit rates to differentiate.

The choice of the tracks by the multi-client multi-rate encoder 112, which correspond to one of the bit rates and a corresponding compression scheme as described above, depends on minimum type of client device, acceptable media quality, preferred/target media quality, network conditions, the compression algorithm chosen, and reasonable differences between two adjacent bit rates. For example, when network bandwidth can fluctuate from a few kbps to 100 kbps, 20 tracks can be generated for a single chunk: the first 8 tracks compressed with AMR and with the rates of 4.75 kbps, 5.15 kbps, 5.9 kbps, 6.7 kbps, 7.4 kbps, 7.95 kbps, 10.20 kbps, 12.20 kbps; the next tracks compressed with W-AMR with the rates of 14.25 kbps, 15.85 kbps, 19.85 kbps, 23.85 kbps, and the next two tracks using AACPlus with the bit rates of 32 kbps and 48 kpbs, and the remaining tracks encoded with MP3 at bit rates between 40 kbps and 100 kbps.

Since each client device 130 can be of one of many different types as mentioned above, with each type having a different capability: cpu power, memory, compression scheme supported, how fast the client can switch from one player (that plays one encoded chunk) to the next player (that plays the next encoded chunk). The present invention uses these various different cellphone parameters to determine a cellphone profile table (shown in FIG. 3(b) of different types for each different chunk, and then for each different types, the track/bit rate, compression, and the average chunk duration that should be used. For example: cellphone A support only AMR, and cellphone B supports only AAC. The multi-client multi rate encoder 112 generates many sets of audio output, including one encoded with AMR (to be used by A), and another with AAC (to be used by B).

Also, in use, a separate hint track with bit rate/compression information for all tracks (of different bit rate/compression combinations) is also generated and supplied to the client device 130 at the beginning of a session that tells the client device 130 the different existing tracks that exist for each encoded chunk, and the approximate starttime and endtime for each encoded chunk, based on an chunk index scheme. For example, the hint track will notify the client device that the media content in issue has 12 tracks, and the target combination (of bit rate/compression) for each track. In addition, the hint track can also be used through the download of the media content, so that information on each chunk can be obtained—such as chunk #2 has 8 tracks (bit rate/compression scheme), starts from 7.5 second and has a length of 8.2 seconds.

With respect to the hint track, the hint track has the following fields, as shown in Table I below:

```
TABLE I
hint track format:
Number of tracks = 16
1 = 4750 amr
    (means the first track's bit rate is 4.75 kbps, the compression
    scheme is amr)
2 = 5900 amr
...
16 = 48000 aacplus
Number of encoded chunk = 24
1 = 7340 text_url image_url video_url
    (7340 means the duration of the first encoded chunk is 7340 milli
    seconds, each encoded chunk's start and end time can be easily
    derived from this information. Also the encoded chunk's size is
    encoded chunk duration * current track bit rate text_url
    refers to the url for the text to be displayed when this audio is being
    played, the same for image and video, and they can be null. That
    content will be downloaded when the buffer level is high enough
2 = 5670 text_url image_url video_url
...
24 = 4765 text_url image_url video_url
```

The client application program 132 on the mobile handset device 130 monitors the downloading speed of recent encoded chunks (in the stream buffer 134 associated with the device 130 and the application 132). The downloading speed is averaged over a specified period of time, and can have a widely vary range depending on the wireless network capabilities, in the range of a few kbps to a few mbps. Actions are triggered based on buffer overflow or underflow status, which actions are first generally described below, with a more detailed discussion provided thereafter.

The client program 132 is the preferable way in which to monitor the network as the method described herein is network agnostic: via monitoring the buffer 200 at the client device 130 side, at the application level, the present invention can tell how good or bad the channel is. It is noted that since each encoded chunk can be represented as a file on the server side, and the streaming server 120 can tell the client device 130 the file size before the transmission (such as in a HTTP protocol, there is a content-length field in the http header, and there is no need for the client device 130 to know the size of each encoded chunk a priori, because the system preferably operates on a need to know basis), this assists in allowing the client device 130 to initiate the request for the appropriate track, based upon the application level monitoring of the buffer 200. Nonetheless, other ways to monitor the network channel situation on the client device 130 side can be used. For example, one can monitor the signal-to-noise level at the physical layer. Another way is to monitor the packet loss at the logical layer. Another way is to monitor delay and loss at the IP layer. However, all of these schemes are isolated from the application, and as such aren't the preferred monitoring method.

If the downloading speed is lower than the content rendering rate (the audio decoder has to take an encoded chunk out of the buffer after it finishes playing the previous encoded chunk, hence the rendering rate has to do with the duration of each encoded chunk, not the track characteristics of each encoded chunk), it will lead to decrease in buffer occupancy. When the buffer occupancy is lower than Bl, the client program 132 initiates a switch to a track of lower resolution (bit rate/compression scheme) (commensurate to measured network speed) by requesting the server to send a different set of files (encoded chunks) that are encoded at that lower resolution track. The tradeoff is lower streaming media quality, but this quality is preferred to streams with a substantial number of lost packets. Bₗ is decided by the maximum latency required. The larger the latency can be, the larger Bₗ can be, and the less likely underflow of buffer 200 will happen.

On the other hand, if network speed is higher than current content rendering rate, and the buffer level is higher than Bt, the client program 132 can initiate an upshift to higher resolution track to increase/restore the streaming media quality. The reason why downshifting use Bl and upshifting use Bt is because we want to be conservative: when the buffer level is higher than Bl, if we upshift right away and if it happens that the bandwidth drop again to a very low resolution track, the buffer may deplete very soon. Hence we want to build up the buffer level to a higher value of Bt to play safe.

The downloading protocol can be of any, but in particular well suited for HTTP, in which case the streaming server can be standard stateless web server without any modification. The client simply uses the HTTP protocol to request a file, which corresponds to a chunk encoded at a particular track.

Among other benefits, two distinct benefits stand out: First, eliminated is the requirement to support complicated streaming protocols, such as (RTSP), on the device 132, which complicated protocols are typically currently available only on high end cellphones. Second, eliminated is the requirement for expensive and complicated and non-scalable streaming servers, as the present invention requires only conventional stateless web/wap servers to serve streaming audio content

Streaming server 120 illustrated in FIG. 1 stores all the audio content, which can be precoded or encoded in real time. The transmission network 140, which may include a web server data center 142, will deliver the encoded chunks of audio content to devices 130, such as cellphones or other mobile devices, typically based on file name of the content. A load balancer 144 can be optionally placed in front of web server data center 142 for better response time.

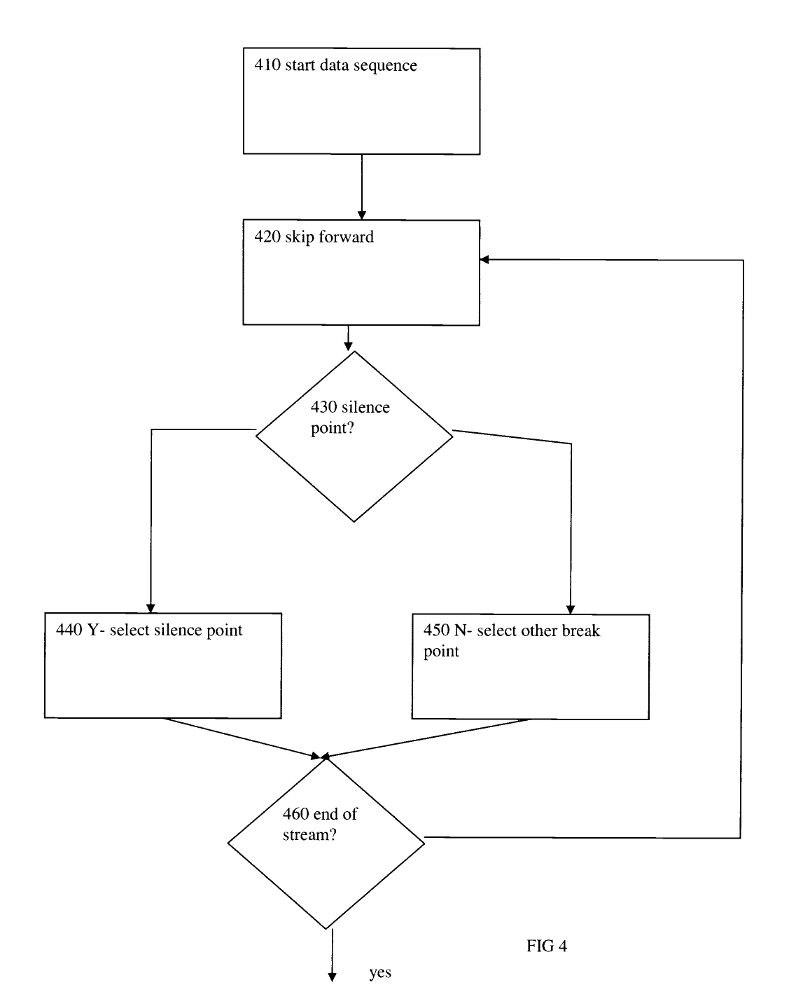

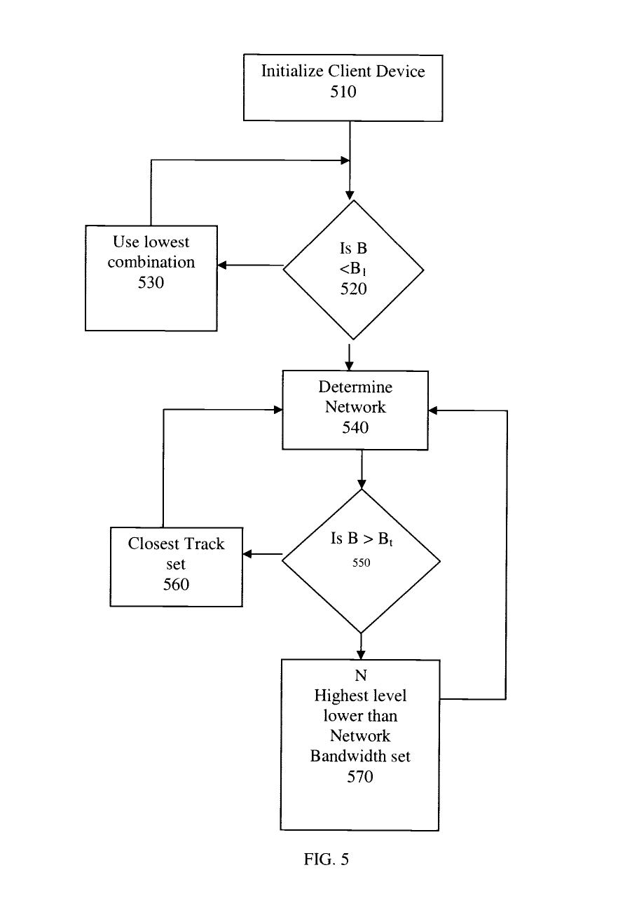

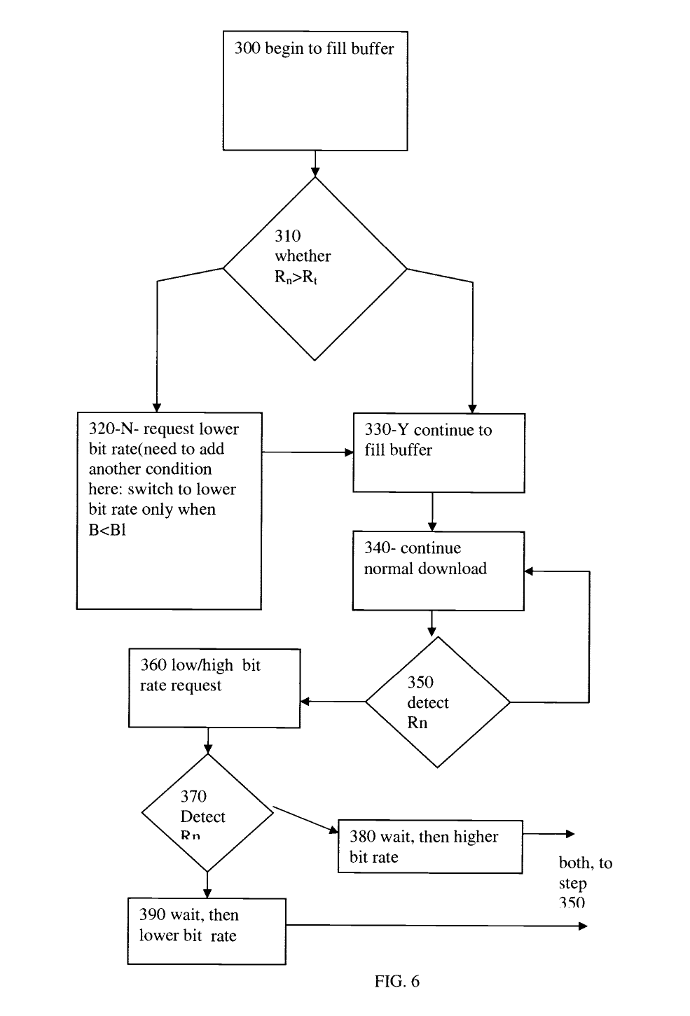

The program 132 of the streaming client device 130 that requests encoded chunks will now be described with reference to the flowcharts of FIGS. 5 and 6, each of these being alternative implementations. It should be understood, however, that there are also other manners in which the buffer or other characteristics can be monitored in order to adjust the bit rate/compression scheme, and still fall within the scope of the present invention.

The following annotations are used for both the flowcharts of FIGS. 5 and 6:
Rₐ=Network bit rate
Rₜ=media track bit rate
Bₜ=target number of encoded chunks in the buffer (which corresponds to a target amount of time of available content for same sized encoded chunks, and roughly corresponds to the target amount of time for intelligent raw chunks as described herein)
Bₗ=buffer low indicator, also the minimum buffer for start playing when Rₙ<Rₜ
T_{c}=encoded chunk length in seconds, e.g. 5 sec
T_{d}=encoded chunk download time in seconds=T_{c}*Rₜ/Rₙ

FIG. 5 illustrates one embodiment of the invention program 132. The buffer 200 is filled to Bₗ in step 510 quickly before rendering using the rendering engine (an audio player or a video player).

Then, preferably before each subsequent encoded chunk is downloaded, or after some number of encoded chunks are downloaded, the track (with the combination of bit rate and compression type for each track) is decided in step 520 so that the client device 130 can inform the server which encoded chunk to send. The track is determined in the following manner: first, the buffer level/occupancy is viewed. If the buffer level is less than Bl, then the lowest track is used in step 530 until the buffer level is larger than Bl.

When B>Bl, the current network bandwidth Rn is first estimated in step 540, based on the network bit rate measured for the previous encoded chunk (encoded chunk size divided by the time it took to download the previous encoded chunk). Then the target track is decided for this current encoded chunk to be downloaded in step 550. The algorithm is: if B>Bt, then the target track is set in step 560 to a closest track of the estimated network bandwidth, which may be a track that has a different combination that has a better quality (with greater bit rate/different compression scheme). If Bl<B<Bt, then the target track is set in step 570 to one level lower than the estimated network bandwidth. Steps 540-570 are then repeated until the end of the media stream, preferably for each encoded chunk, and as shown by the arrows back to step 540.

With respect to the flowchart of FIG. 6, in the initial start step 600, the buffer 200 is filled to Bₜ as quickly as possible.

Preferably after the encoded chunk is downloaded (or after some interval or some other measure) in step 610 there is checked whether Rₙ>Rₜ. If no, step 620 follows. If yes (ideally Rₙ=2*Rₜ), then step 630 follows.

In step 620, since Rₙ<Rₜ the program within the mobile device initiates a request for a track at a lower bit rate/compression scheme Rₜ^{low} right away, based on the measured Rₙ, so that an Rₜ is chosen that is lower than Rₙ. Once encoded chunks at this track combination are being received, then step 630 follow (to ensure that buffer 200 will gradually grow to Bₜ).

In step 630, the content within the buffer 200 is begun to get serially read out in sequence for rendering, while downloading of additional encoded chunks into the buffer 200 continues as fast as possible.

After Bₜ is reached, step 640 follows, and the download is slowed to a normal rate. Every T_{c}, an encoded chunk is downloaded, so that content is being downloaded into buffer 200 at the same rate it is being output from buffer 200.

At each encoded chunk downloaded, preferably Rₙ is calculated in step 650 and a determination of the network conditions is made, based upon the low threshold Bₗ, as will now be described.

If conditions are normal, then step 640 repeats. If Rₙ<Rₜ, the amount of data content in the buffer 200 will decrease, and a lower track resolution is likely needed. It is noted, however, that temporary fluctuation are permitted, so that the overall system will not change based on a temporary fluctuation. In order to determine that a fluctuation is significant, however, the present invention tracks some other measure, preferably a low threshold Bₗ, which corresponds to a low threshold amount of content data in the buffer 200.

If Bₗ is reached, step 660 follows and the program 132 at the client device 130 initiates a request for a track of a lower bit rate/compression scheme, Rₜ^{low}<Rₙ, to ensure that the buffer 200 will gradually grow to Bₜ. Alternatively, if Rₜ<Rₙ, instead of Bₗ being reached, a track of higher resolution can be requested.

After step 660, the buffer 200 should grow from Bₗ to Bₜ There are, however two possibilities. Both are based on the detected Rₙ as shown by step 670.

In the first, the buffer 200 grows, and Rₜ<Rₙ. While normally, as discussed above, this would indicate that a change to a higher resolution track, in this instance, a wait period of one encoded chunk occurs, as shown by step 680, before changing to a higher resolution track to avoid overreaction, since the increase in Rₙ can be temporary, just like the temporary decreases as noted above.

In the second possibility, it is determined that Rₙ still decreases below Rₜ, which would indicate that a change to a lower resolution track. Similarly as describe above, however, in step 690, a wait period occurs so that a change to a further lower resolution track is not made until Bₗ is again reached, in order to avoid a continued oscillation of track changes.

With respect to parameter setting for Bₜ and Bₗ, the difference Bₗ between Bₜ is actually the window in which we observe the network bit rate fluctuation. Bₗ is set so that with the roundtrip delay during downshifting to a lower resolution track, the buffer will not be depleted: Bₗ>(Rₜ−Rₙ)*T_{roundtrip}.

Bₜ−Bₗ is determined by the statistical behavior of track change frequency and range. If the track changes very often, in order of T_{c}, the window should be large to accommodate such frequent change. If the track changes dramatically (e.g., from 20 kbps to 2 kbps), the buffer 200 can deplete quickly, in this case Bₜ should also be made larger. It should be understood, however, that it's not the case that the larger the Bₜ, the better, as this will waste network bandwidth (and users will potentially have to pay more) if the user abandons the transmission, or do a backward rewind to peruse content again. Therefore, Bₜ is preferably decided by how often the track change and how dramatically it changes.

In the above-described embodiment, if the buffer 200 undesirably depletes, the rendering/play is stopped, waiting for the next encoded chunk to arrive. In normal operation, the buffer 200 needs to be filled to Bₜ as described above before rendering will being, which also assists in ensuring that the rendering will last if the network condition become bad again. The drawback with such an implementation, however, is that such buffering requires a longer time, leading to bad user experience. In order to minimize such breaks in streaming, in another aspect, current network bandwidth is reviewed, and if the current network bandwidth is higher than the lowest encoding track and the transmission of content data encoded chunks is at that lowest bit, then rending is started right away, even if the level of the buffer 200 is not yet at the normal level Bₜ.

It should be apparent that other algorithms can be used to determine which track to use for a particular encoded chunk.

Given the above description, an application level multicast support and unicast caching support feature will now be discussed.

In one particular implementation of the system shown in FIG. 1, each client device 130 will use an HTTP protocol to retrieve files from the streaming server 120 or the data center 142, as described above. Since content data is divided into encoded chunks, each of which is essentially a file with a URL, the combination of client device 130 initiated adaptation and the use of an HTTP protocol lead to a benefit that media encoded chunks (files) can be automatically buffered at Internet web cache servers within the network 140. This can lead to significant bandwidth saving and server CPU savings, as the content data will not always need to be extracted from the streaming server 120 or the data center 142. Thus, if many users are requesting the same content (if at the same time, called multicast, otherwise called unicast) (for example when user device 130-A is retrieving encoded chunks from a concert show), the encoded chunks it retrieves are cached at a nearby cache server. When another user device 130-B's then attempts to retrieve the same content with the same set of encoded chunks, many of the files are served directly from the cache server, eliminating the need to go back to the streaming server 120, thus reducing server load and server bandwidth. Not all of the files, will be served directly from the cache server, however, since the particular track that was used for user device 130-A may not be the same track used by the device 130-B for the same encoded chunk of content data. It is also noted that while timing information is not needed in order for the application on the client device 130 to determine what next encoded audio chunk is needed, timing information is preferably obtained, as shown above by the information provided in the hint track, in order to allow for other media content, such as an image or video, to be rendered at some specific time or duration during the streaming of the audio content.

Although the present invention has been particularly described with reference to embodiments thereof, it should be readily apparent to those of ordinary skill in the art that various changes, modifications and substitutes are intended within the form and details thereof, without departing from the spirit and scope of the invention. Accordingly, it will be appreciated that in numerous instances some features of the invention will be employed without a corresponding use of other features. Further, those skilled in the art will understand that variations can be made in the number and arrangement of components illustrated in the above figures. It is intended that the scope of the appended claims include such changes and modifications.

What is claimed is:

1. A method of providing a media stream over data channel of a best effort transmission network that includes a wireless path to a plurality of client devices, each of the plurality of the client devices including a transceiver, a processor, a memory that includes a content buffer having a predetermined size, and an application that monitors the content buffer, the media stream obtained from a plurality of tracks each formed of sequentially encoded chunks that are encoded at one of a plurality of combinations of different bit rates and compression schemes, the method comprising the steps of:
initiating at one of the plurality of client devices a request for the media stream;
responsive to the request, obtaining information on a set of the plurality of combinations for that one client device in the memory of the one client device and a first portion of the streaming media in the content buffer of the one client device, the first portion corresponding to one of the plurality of combinations of sequentially encoded chunks;
beginning to render, at the one client device, the streaming media using the plurality of sequentially encoded chunks corresponding to the one combination, the step of rendering causing a reduction in available sequentially encoded chunks within the content buffer; and
determining, at the one client device using the application, whether a current combination is appropriate to continue rendering the streaming media using information obtained from a fullness of the content buffer, said information not including information obtained from parsing a bitstream of data within the sequentially encoded chunks;
if the current combination is appropriate, continuing to receive a further portion of the streaming media at the current combination in the content buffer, and continuing to render the first portion of the streaming media and the further portion of the streaming media using the sequentially encoded chunks corresponding to the current combination; and
if the current combination is not appropriate, initiating at the one client devices another request for the streaming media at another of the combinations that is different than the current combination,
responsive to the another request, obtaining another portion of the streaming media in the content buffer of the one client device, the another portion including another plurality of sequentially encoded chunks corresponding to the another combination; and
beginning to render, at the one client device, the streaming media using the another portion of the streaming media after rendering the first portion of the streaming media; and
repeating the step of determining throughout providing remaining portions of the media stream.

2. The method according to claim 1, wherein the fullness of the content buffer in the step of determining if the current combination is appropriate monitors whether a buffer level is below a predetermined threshold.

3. The method according to claim 2 wherein the step of determining determines that the current combination is not appropriate, and wherein the step of obtaining the another portion of the streaming media continues using the another of the combinations.

4. The method according to claim 2 wherein the step of determining determines that the current combination is appropriate, and wherein the step of obtaining obtains the further portion of the streaming media using the current combination of bit rate and compression scheme.

5. The method according to claim 1 wherein the streaming media includes audio content and wherein each of the sequentially encoded chunks has a duration of 5-10 seconds to reduce startup latency and maintain substantially real-time streaming.

6. The method according to claim 4 further including the step of creating the sequentially encoded chunks, and wherein the step of creating includes the steps of:
inputting data corresponding to the media stream;
creating a plurality of chunks from the media stream, the step of creating including:
determining, for each chunk, a window of time to cause an end to the chunk from a beginning chunk start point;
within the window of time for each chunk, determining a break point that substantially corresponds to a silence point; and
encoding each chunk into an encoded chunk.

7. The method according to claim 6 wherein the silence point for at least some of the break points correspond to a signal strength that is less than 5% of maximum amplitude.

8. The method according to claim 6 wherein the step of encoding includes encoding each chunk at each of the plurality of combinations of different bit rates and compression schemes.

9. The method according to claim 8 wherein the plurality of combinations are separable into different pluralities of sets, and wherein the set corresponds to the one client device.

10. The method according to claim 9 wherein at least some of the sets have as the plurality of combinations, at least one combination at one bit rate and one compression scheme and another combination at another bit rate different than the one bit rate and another compression scheme different than the one compression scheme.

11. The method according to claim 6 wherein the streaming media further includes video content, and wherein the break points of the video content corresponds to the break points of the audio content.

12. The method according to claim 1 further including the step of storing at least some of the sequentially encoded chunks at a cache server.

13. The method according to claim 1 wherein each of the sequentially encoded chunks is addressable by filename from the client device; and wherein the information on the set of the plurality of combinations allows the client device to request the filename.

14. The method according to claim 9 wherein the steps of are repeated for another one of the plurality of client devices.

15. The method according to claim 1 wherein the continuing to receive a further portion of the streaming media at the current combination obtains the further portion from a cache server.

16. The method according to claim 1 wherein the plurality of client device numbers over at least one hundred, wherein each of the steps are repeated for each of the over one hundred client devices, and wherein there is overlap between the steps performed for each of the least one hundred client devices.

17. The method according to claim 1 wherein the first portion of the streaming media is encoded at a combination having a lowest bit rate to allow for the step of beginning to render to occur as fast as possible.

18. The method according to claim 1 further including the step of including other media at a determined period of the media stream.

19. A method of encoding a stream of data into a plurality of a plurality of tracks encoded with a plurality of combinations of different bit rates and compression schemes, each of the plurality of tracks including a plurality of encoded chunks that can be used by a plurality of client devices at a plurality of the media stream obtained from different bit rates comprising the steps of:
inputting the stream of data;
operating upon the stream to create a plurality of sequential chunks corresponding to the stream, the step of operating including the steps of:
determining, for each chunk, a window of time to cause an end to the chunk; and
within the window of time, determining a break point that corresponds to a silence point.
encoding each of the plurality of sequential chunks to create the plurality of encoded chunks that support the plurality of client devices at a plurality of different bit rates and compression schemes.

20. A method for creating a library of encoded media for a media stream and linking the library to a plurality of cell phone devices including the steps of:
receiving a plurality of sequential chunks corresponding to the media stream;
inputting a plurality of variables for each of the different plurality of cell phone devices;
determining a set of tracks corresponding to each of the plurality of cell phone devices based upon the plurality of variables; and
encoding tracks that correspond to each of the tracks in each of the set of tracks, the step of encoding each set so that each track therein has a combination of different bit rates and compression schemes.
